(19) United States
(12) Patent Application Publication
(10) Pub. No.: US 2014/0021734 A1
(43) Pub. Date: Jan. 23, 2014

(54) MOVEMENT DEVICE FOR A MOTOR VEHICLE INTERIOR TRIM PART, AND INTERIOR TRIM PART

(71) Applicant: Patrick Welter, Lachambre (FR)

(72) Inventor: Patrick Welter, Lachambre (FR)

(21) Appl. No.: 13/980,694

(22) PCT Filed: Jan. 19, 2012
(86) PCT No.: PCT/EP2012/000236

§ 371 Date: Oct. 8, 2013

(30) Foreign Application Priority Data
Jan. 20, 2011 (DE) 10 2011 009 065.7

(51) Int. Cl. B60J 3/02

(52) U.S. Cl. CPC B60J 3/0282
USPC 296/97.4

(57) ABSTRACT

Proposed is a movement device for an interior trim part in a motor vehicle, wherein the movement device comprises a first component and a second component, wherein the second component is movable relative to the first component between a first position and a second position, wherein the movement device comprises an energy store element which is provided for moving the second component in the direction of the first position and/or in the direction of the second position, and wherein the movement device furthermore has a retardation element which partially retards the movement of the second component in the direction of the first position and/or in the direction of the second position.

### PRIOR ART

The invention relates to a movement device for an interior trim part in a motor vehicle. Furthermore, the invention relates to an interior trim part which is provided with the movement device according to the invention.

Movement devices of this type are generally known. For example, documents DE 10 2008 027 923 A1 and DE 10 2007 037 411 A1 have disclosed sun visors for a motor vehicle, which sun visors can in each case be pivoted between a use position and a non-use position relative to a roof lining of the motor vehicle. The sun visors in each case have a mirror and a pivotable cover which is part of a movement device. When the sun visor is transferred into the use position, the cover can be pivoted between a closed position which covers the mirror and an open position which exposes the mirror. The cover is usually prestressed in the direction of the closed position by way of a spring element which, when the cover is pushed manually in the direction of the closed position by a user, additionally drives the cover in the direction of the closed position, in order to continue the closing movement automatically.

This has the disadvantage that the cover is accelerated by the spring element virtually during the entire closing movement in the direction of the closed position and is therefore braked suddenly at the end of the closing movement by coming into contact with a substantially immovable component. This sudden braking is unpleasant for a user and additionally causes an undesired stop noise.

### DISCLOSURE OF THE INVENTION

It is the object of the present invention to provide a movement device, in which an opening and/or closing movement of a movable component is carried out in a manner which is low in noise and pleasant for the user. In particular, sudden braking movements of the movable component are to be avoided for this purpose. At the same time, furthermore, a comparatively rapid opening and/or closing movement is to be ensured, however.

This object is achieved by a movement device for an interior trim part in a motor vehicle, the movement device comprising a first component and a second component, it being possible for the second component to be moved relative to the first component between a first position and a second position, the movement device comprising an energy store element which is provided in order to move the second component in the direction of the first position and/or in the direction of the second position, and, furthermore, the movement device having a retarding element which retards the movement of the second component in the direction of the first position and/or in the direction of the second position partially.

As a result, the movement of the second component which can be moved with respect to the first component is advantageously retarded partially, with the result that a sudden braking movement of the second component when the first position or the second position is reached is avoided. In particular, a type of “soft close” mechanism for the interior trim part of the motor vehicle is realized hereby. Said “soft close” mechanism is preferably realized both for a closing movement and for an opening movement of the second component. In the context of the present invention, the expression “retarded partially” means that the movement of the second component along a movement path in the direction of the first or second position is retarded, in particular, only in a part region of the entire movement path. The movement path preferably comprises a first part path and a second part path, the movement device being configured in such a way that the retarding acts on the second component in each case merely in the second part path. This has the advantage that, despite the “soft close” mechanism, a comparatively rapid opening and/or closing movement, for example, can be achieved, since the first part path is passed through without retarding. A retarding element in the context of the present invention is configured, in particular, in such a way that the movement of the second component is retarded with a virtually constant retarding action independently of the angular position of the second component in the second part path.

It is therefore provided according to the invention to initiate the opening and/or the closing movement of the cover in a manner which is very pleasant for the user, by said user initiating the movement of the cover in the movement direction “opening” or “closing” which is currently required and by the cover moving over the remaining movement path into the respective end position in a manner which is spring-assisted. Here, the movement is retarded before the end stop of the open position and/or the closed position is reached.

It is provided according to one preferred embodiment that the second component is attached to the first component via at least one hinged connection, it being possible for the second component to be pivoted relative to the first component about a pivot pin by means of the hinged connection. The retarding element is arranged, in particular, adjacently with respect to the at least one hinged connection. The retarding element is mounted such that it can be pivoted about the pivot pin both relative to the first component and relative to the second component. This has the advantage that the retarding element has a certain free movement with regard to the pivoting movement about the pivot pin both in respect of the first component and in respect of the second component. As a result, the retarding element is not coupled to the first and the second component over the entire length of the movement path. Accordingly, the retarding action is developed only in a part region of the entire movement path. The retarding element preferably comprises a disk-like structural element which is arranged between two guide receptacles of the first component, a retarding medium, in particular a viscous retarding medium, preferably adhesive grease, being arranged in each case between the disk-like structural element and the guide receptacles. As a result of the adhesive grease which is arranged between those end faces of the guide receptacles which face the disk-like structural element and the end faces of the structural element, a relative movement between the disk-like structural element and the guide receptacles is braked with a virtually constant force which is additionally independent of the deflection angle of the second component.

It is provided according to one preferred embodiment that the second component has a first driver geometry which, in a first intermediate position, can be brought into contact with a complementary first bearing region of the retarding element during the movement of the second component from the first position into the second position. Furthermore, the second component has a second driver geometry which, in a second intermediate position, can be brought into contact with a complementary second bearing region of the retarding element during the movement of the second component from the second position into the first position. During the closing and/or opening movement, the second component does not pass into a coupling connection with the retarding element until the first or second intermediate position is reached, with the result that the retardation occurs only from the first or second intermediate position. This has the advantage that a non-retarded and therefore rapid closing and/or opening movement is ensured before the first or second intermediate position is reached.

The first driver geometry preferably has an indentation in the second component, into which indentation, in order to drive the retarding element, the first bearing region which is configured as a bulge engages during the movement of the second component from the first intermediate position into the second position, whereas the second driver geometry comprises a lug-shaped projection of the second component, which lug-shaped projection, in order to drive the retarding element, engages into the second bearing region which is configured as a groove during the movement of the second component from the second intermediate position into the first position.

In particular, the invention can always be used when one component (the second component here) is to be moved from a first end position (first position) into a second end position (second position) without an intermediate position with the assistance of an energy store, for example a spring. The covers of makeup mirrors, ashtrays, glove compartments, spectacle compartments or other storage compartments or handles which can be folded out are to be mentioned here as second component by way of example but in no way in a restrictive manner.

The invention is to be explained in greater detail using the example of a makeup mirror cover in a sun visor for a motor vehicle. Sun visors of this type are usually attached in a foldable manner to the roof lining of the vehicle and bear with a first flat side against the roof lining in the stored position. Here, the second flat side which lies opposite the first flat side is visible to the vehicle occupant. After the sun visor has been folded down into an approximately vertical shade position in front of the windshield, said second flat side points in the direction of the windshield and the first flat side becomes accessible for the vehicle occupants. It is known to equip sun visors according to the invention on the first flat side with functional elements, for example mirrors, illumination devices or operating elements. The functional elements are preferably combined to form one functional unit and are fastened with a housing in a depression of the first flat side of the sun visor. A cover preferably covers the functional elements in the non-use position in order to protect them against undesired external actions and for esthetic reasons. The functional elements which lie underneath said cover become operable by the vehicle occupant only after the cover is opened. Thus, for example, said vehicle occupant can actuate the illumination device by way of a switch. It is preferred to control the method of operation of at least some of the functional elements in a manner which is dependent on the opening movement. For example, the illumination unit which is responsible for illuminating the field of vision is switched on when the open end position of the cover is reached, and is extinguished again during closing of the cover. The opening of the cover usually takes place in a manually actuated manner. For example, the cover is moved by hand into its open and closed position over the entire distance. A further possibility is afforded by a lock, after the triggering of which the cover moves in a spring-assisted manner directly against the end stop of the open position at least in its opening movement. In order to avoid or at least to reduce the stop noise which occurs in the process, recourse is made to elastic buffers or molded plastic springs. Occasionally, the interior of the cover is provided with a textile covering which damps the end stop when the closed position is reached. Furthermore, what are known as silicone brakes are known, in which a fluid in a cylinder is displaced by a piston. In this way, for example, the cover of an ashtray or a roof holding handle is moved in a braked manner over its entire deflection extent. In the movement device according to the invention, the movement of the cover is then braked in a part region of the entire movement path, with the result that neither retardation over the entire deflection extent nor retardation only at the end stop is realized. The consequence is a comparatively pleasant, uniform and nevertheless rapid opening and/or closing movement of the cover.

Further details, features and advantages of the invention result from the drawings, and from the following description of preferred exemplary embodiments using the drawings. Here, the drawings illustrate merely exemplary embodiments of the invention which do not restrict the essential concept of the invention.

### BRIEF DESCRIPTION OF THE FIGURES

In the drawings:

FIGS. 1 to 5 show diagrammatic perspective views of an interior trim part of a motor vehicle, which interior trim part has a movement device according to one exemplary embodiment of the present invention, and

FIGS. 6 and 7 show diagrammatic sectional views of an interior trim part of a motor vehicle, which interior trim part has a movement device according to the exemplary embodiment of the present invention.

### EMBODIMENTS OF THE INVENTION

In the various figures, identical parts are always provided with the same designations and will therefore also as a rule be named or mentioned in each case only once. The appended figures show one embodiment of the invention in an exemplary and diagrammatic manner.

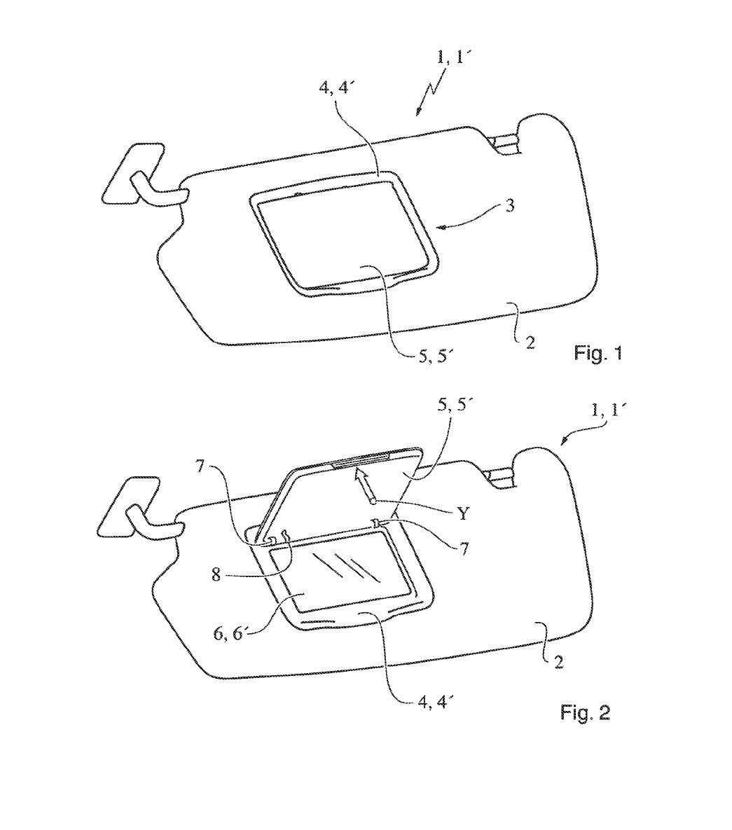

FIGS. 1 to 8 illustrate an interior trim part 1′ of a motor vehicle, which interior trim part 1′ is configured as a sun visor 1 and has a movement device according to one exemplary embodiment of the present invention. In the present example, the movement device has a first component 4′ and a second component 5′ which can be moved with respect to the first component 4′. The second component 5′ comprises a cover 5 which is attached to the first component 4′ which is configured as a frame 4. Furthermore, the frame 4 encloses a functional element 6′ which is configured as a mirror 6 in the present example. The cover 5 can be pivoted between a closed position (illustrated in FIG. 1) which covers the mirror 6 and an open position (illustrated in FIG. 2) which exposes the mirror 6. The cover 5 is situated in a first position A (illustrated in FIG. 7) in the open position, whereas it is situated in a second position B (illustrated in FIG. 8) in the closed position. In order to transfer it from the first position A into the second position B and vice versa, the cover 5 is moved along a movement path 100. Here, the movement of the cover 5 is assisted or driven by means of an energy store element 12 which is configured as a leaf spring. The movement is retarded by a retarding element 8 in a part region 101 of the entire movement path 100, in order to integrate a type of “soft close” mechanism and thus to realize a pleasant, uniform and nevertheless rapid opening and/or closing movement of the cover 5. The retarding element 8 is configured in such a way that a movement of the retarding element 8 about a pivot pin 9 with respect to the frame 4 is retarded by means of an adhesive grease, and that the retarding element 8 is coupled to the cover 5 only in the part region 101 and is therefore also driven with the cover 5 only in the part region 101. The proportion of the part region 101 to the entire length of the movement path between the first and the second position preferably comprises in each case between 5 and 50%, particularly preferably between 10 and 40% and particularly preferably between 15 and 35%. In detail:

FIG. 1 shows the sun visor 1 in its shade position, in which it is oriented approximately vertically with respect to the roof lining (not shown) of the vehicle roof of a motor vehicle. As a result, it covers an upper part region of the windshield (likewise not shown) of the motor vehicle. The sun visor 1 has a first flat side 2 and a second flat side (not shown) which lies opposite the former. A functional unit 3 is fastened in a depression of the flat side 2 (readily visible in FIGS. 7 and 8), of which functional unit 3 only the frame 4 and the cover 5 can be seen in its non-use position which is shown. Furthermore, the functional unit 6 has the mirror 6 in the present example.

FIG. 2 shows the sun visor 1 from FIG. 1 in the shade position, with an open cover 5. Here, the arrow Y indicates the opening direction. The functional device 3 which is normally covered by the cover 5 now becomes visible. In this embodiment, merely the mirror 6 can be seen. The functional device preferably additionally has an illumination device (not shown) which can be arranged, for example, in the surrounding frame or in the cover. If an OLED (organic light emitting diode) is used as illumination means, the illumination device could also be integrated into a part region of the mirror surface. The cover 5 is fastened to the frame 4 by way of at least one hinged connection 7, preferably two hinged connections 7, however, so as to form a pivot pin 9. Here, the two hinged connections 7 are particularly preferably spaced apart from one another as far as possible on the pivot pin 9, but are still arranged along the pivot pin 9 within the extent of the cover or the frame.

Moreover, FIG. 2 shows the at least one retarding element 8 which, in the exemplary embodiment which is shown, is arranged adjacently with respect to one of the two hinged connections 7. It is responsible for the special kinematics of the cover 5 and will be described in detail in the following figures.

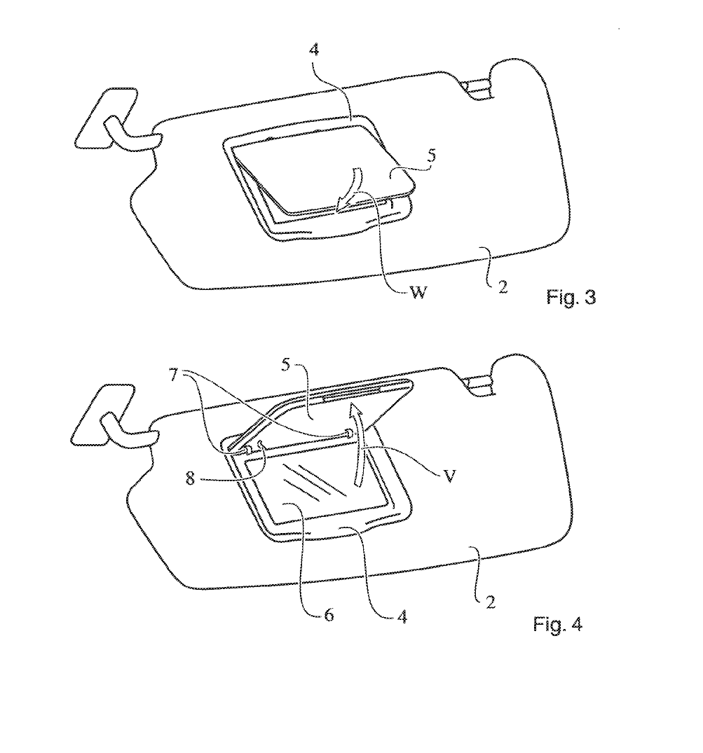

In FIG. 3, the arrow W indicates that the cover is currently moving into its closed position (in the direction of the second position B). In an approximation of the angular position which is shown of the cover 5, the retardation as a result of the action of the retarding element 8 is additionally initiated.

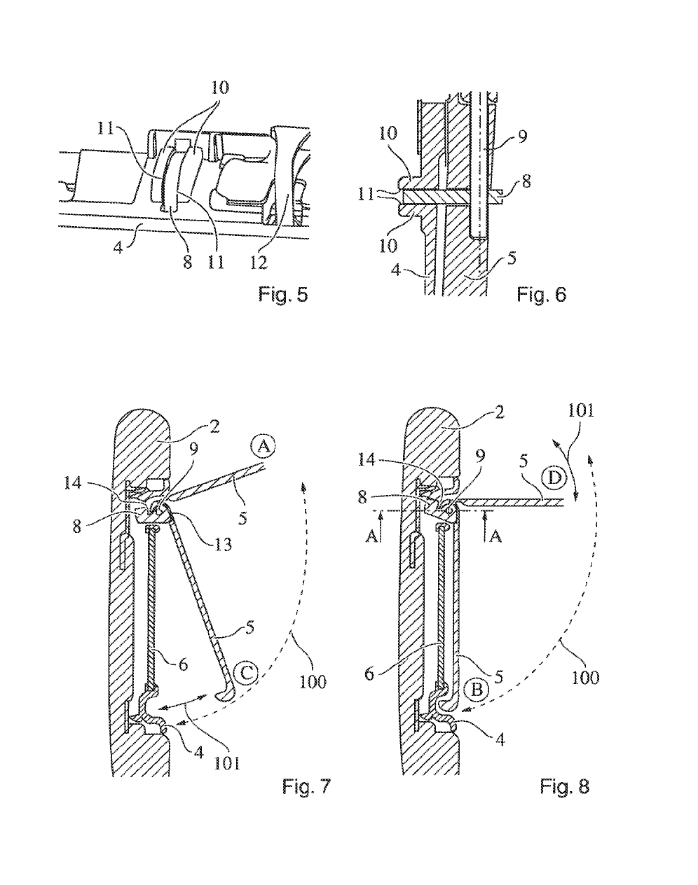

FIG. 4 illustrates the opening operation of the cover 5, the arrow V representing the opening movement. In an approximation of the angular position shown here of the cover 5, the retardation action which is caused by the retarding element 8 is also initiated here. The construction of the retarding element 8 in this exemplary embodiment is to be described using FIGS. 5 and 6. Its method of operation will be explained afterward using FIGS. 7 and 8.

FIG. 5 shows a perspective detail of the functional unit 3 with a part of the frame 4, which detail shows the region of the hinged connection 7 with an adjacent retarding element 8 from FIG. 4 on an enlarged scale. The retarding element 8 can be seen there as a disk-like component which is situated between two guide receptacles 10 which are formed integrally on the frame 4. The fit between retarding element 8 and respectively adjacent left-hand and right-hand guide receptacle 10 affords sufficient play, in order to receive a retarding medium 11, for example an adhesive grease. Said grease also still adheres reliably to the fitting surfaces even at relatively high temperatures, as can occur in a motor vehicle.

Moreover, the energy store 12 can be seen in FIG. 5, which energy store 12 by way of example here consists of a leaf spring. Any other form of energy store is also conceivable however. The energy store 12 provides the drive to pivot the cover 5 form one of the end positions ‘open’ or ‘closed’ into the respective other end position.

FIG. 6 represents a horizontal section through the pivot pin 9 in accordance with the sectional line A-A from FIG. 8. Once again, the disk-shaped cross-sectional form of the retarding element 8 and the retarding medium 11 between the two guide receptacles 10 can be seen in said figure. At its end which faces away from the guide receptacles 10, the retarding element 8 is mounted rotatably with play on the pivot pin 9. A rotational movement of the pivot pin 9 therefore has no effect on the angular deflection of the retarding element 8.

FIG. 7 illustrates the method of operation during the closing operation of the cover in a vertical section through the retarding element 8. From the first end position A which corresponds here to a completely open cover 5, the cover 5 is pivoted downward about the pivot pin 9. When the first intermediate position C is reached, the first driver geometry 13 comes into contact with a complementary bearing face of the retarding element 8 and forces the latter to follow the movement of the cover 5 in the case of further pivoting in the same direction. The drive energy of the energy store 12 causes the cover 5 to move further counter to the resistance of the retarding medium 11 in the direction of the second end position B, until the latter is reached.

FIG. 8 shows the method of operation during the opening operation of the cover in a vertical section through the retarding element 8. Starting from the second end position B which represents the closed state of the cover 5, the cover 5 is opened by pivoting upward about the pivot pin 9. When the second intermediate position D is reached, a second driver geometry 14 of the cover 5 which is configured, for example, as an integrally molded lug makes contact with a complementary bearing face of the retarding element 8 and forces the latter to follow the movement of the cover 5 in the case of further pivoting in the same direction. This co-movement again takes place in a manner which is braked by the retarding medium 11 until the cover 5 has reached its first end position A.

### LIST OF DESIGNATIONS

1 Sun visor
1′ Interior trim part
2 First flat side
3 Functional unit
4 Frame
4′ First component
5 Cover
5′ Second component
6 Mirror
6′ Functional element
7 Hinged connection
8 Retarding element
9 Pivot pin
10 Guide receptacle
11 Retarding medium
12 Energy store
13 First driver geometry
14 Second driver geometry
100 Movement path
101 Part region
A First end position
B Second end position
C First intermediate position
D Second intermediate position
Y Opening direction
V Opening movement
W Closing movement

1.-14. (canceled)

15. A movement device for an interior trim part in a motor vehicle, the movement device comprising a first component and a second component movable relative to the first component between a first position and a second position, the movement device comprising an energy store element configured to move the second component in the direction of the first position and/or in the direction of the second position, the movement device comprising a retarding element which retards the movement of the second component in the direction of the first position and/or in the direction of the second position partially.

16. The movement device as claimed in claim 15, wherein the second component is movable between the first and second positions along a movement path, the retarding element being configured to retard movement of the second component in the direction of the first position and/or in the direction of the second position only in a part region of the entire movement path.

17. The movement device as claimed in claim 15, wherein the second component is attached to the first component via at least one hinged connection, the second component being pivotable relative to the first component about a pivot pin by the hinged connection.

18. The movement device as claimed in claim 17, wherein the retarding element is arranged adjacently with respect to the at least one hinged connection, and/or the retarding element is mounted pivotable about the pivot pin both relative to the first component and relative to the second component.

19. The movement device as claimed in claim 1, wherein the retarding element comprises a disk-like structural element arranged between two guide receptacles of the first component, and wherein a retarding medium is arranged between the disk-like structural element and the guide receptacles.

20. The movement device as claimed in claim 19, wherein the retarding medium comprises a viscous retarding medium.

21. The movement device as claimed in claim 20, wherein the retarding medium comprises adhesive grease.

22. The movement device as claimed in claim 15, wherein the second component comprises a first driver geometry which, in a first intermediate position, can be brought into contact with a complementary first bearing region of the retarding element during movement of the second component from the first position into the second position.

23. The movement device as claimed in claim 22, wherein the first driver geometry comprises an indentation in the second component, into which indentation, in order to drive the retarding element, a first bearing region which is configured as a bulge engages during the movement of the second component from the first intermediate position into the second position.

24. The movement device as claimed in claim 22, wherein the second component comprises a second driver geometry which, in a second intermediate position, can be brought into contact with a complementary second bearing region of the retarding element during the movement of the second component from the second position into the first position.

25. The movement device as claimed in claim 24, wherein the second driver geometry comprises a lug-shaped projection of the second component, which lug-shaped projection, in order to drive the retarding element, engages into the second bearing region which is configured as a groove during the movement of the second component from the second intermediate position into the first position.

26. The movement device as claimed in claim 15, wherein the movement device comprises a functional element, the second component comprising a cover for the functional element, the cover being movable between a closed position and an open position.

27. The movement device as claimed in claim 26, wherein the functional element comprises a mirror, a storage compartment, an ashtray and/or a handle, and/or wherein the interior trim part comprises a sun visor.

28. The movement device of claim 26, wherein the first component comprises a frame for the functional element.

29. An interior trim part in a motor vehicle having a movement device as claimed in claim 15.
